(19) United States
(12) Patent Application Publication
(10) Pub. No.: US 2009/0062058 A1
(43) Pub. Date: Mar. 5, 2009

(54) Plantary Transmission Having Double Helical Teeth

(76) Inventors: John W. Kimes, Wayne, MI (US); Mark W. Rosselot, Saline, MI (US); Greg D. Gardner, Livonia, MI (US); John D. Emilio, JR., Canton, MI (US); James Rutter, Canton, MI (US); Matthew T. Trent, South Lyon, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/845,388

(22) Filed: Aug. 27, 2007

(51) Int. Cl. F16H 57/08

(52) U.S. Cl. 475/344

(57) ABSTRACT

A planetary gear set includes a sun gear including a first set of gear teeth having a helix angle and second set of gear teeth formed as a single unit with the first set of gear teeth and having a second helix angle of opposite hand relative to the first helix angle. A ring gear includes a third set of gear teeth having a third helix angle, and fourth set of gear teeth and having a fourth helix angle of opposite hand relative to the third helix angle. Planet pinions, each include a fifth set of gear teeth having a fifth helix angle, and sixth set of gear teeth formed as a single unit with the fifth set of gear teeth and having a sixth helix angle of opposite hand relative to the fifth helix angle.

### BACKGROUND OF THE INVENTION

1. Field of the Invention

The present invention relates generally to a power transmission, particularly to a planetary gear set having helical gear teeth.

2. Description of the Prior Art

Due to noise associated with the operation of spur gears, it has become conventional for gear assemblies of automotive transmissions to include helical gearing to provide quieter operation. However, a recognized design constraint associated with helical planetary gear sets is the axial thrust component of the tangential loads that transmit torsion between the mating gear teeth. The axial component is caused by the helix angles of the mating gear teeth.

In a planetary gear unit, a sun gear and ring gear mesh with each planet pinion. Thrust loads, applied to each planet pinion in opposite axial directions at the lines of contact due to its two meshing engagements, induce an overturning moment on each planet pinion. The reaction to the overturning moment causes additional loading of the bearing, as well as increasing the probability of end loading of the needles on which each planet pinion is supported on its pinion shaft. The additional loading reduces bearing life. In some cases, pinions are added to the assembly to increase bearing life even though the gear life is adequate.

The axial forces cause unwanted loading of other components both inside and outside of the planetary assembly Within the assembly, the axial/moment loads produce an adverse effect on bearings, washers, pinion shafts, carrier surfaces, and pinion bores caused by the overturning moment. Multiple thrust bearings, which are added to most transmission assemblies to react the thrust loads, increase the package space required for the assembly.

In addition, the thrust loads must be reacted outside the assembly, thereby requiring use of expensive external thrust bearings. These requirements increase the manufacturing and assembly cost of the transmission assembly and increase the length of the assembly, which is at a premium particularly in vehicles having front wheel drive, in which the transmission and engine are arranged laterally with respect to the longitudinal axis of the vehicle.

In the automotive industry, it is known that herringbone gears can be used to address the thrust loads associated with conventional helical gearing. Because herringbone/double helical gears are difficult and costly to manufacture, as well as difficult to assemble, they are rarely used in automotive drive trains, transmissions or transfer cases.

A need exists for a technique to limit or avoid use of trust bearings in transmission assemblies and to eliminate the overturning moment induced in planetary transmission planet pinions due to the thrust loads, yet maintain the quiet gear operation associated with helical gear teeth.

### SUMMARY OF THE INVENTION

The planetary gear set includes a sun gear including a first set of gear teeth having a first helix angle and second set of gear teeth formed as a single unit with the first set of gear teeth and having a second helix angle of opposite hand relative to the first helix angle. A ring gear includes a third set of gear teeth having a third helix angle, and fourth set of gear teeth having a fourth helix angle of opposite hand relative to the third helix angle. Planet pinions, each include a fifth set of gear teeth having a fifth helix angle, and sixth set of gear teeth formed as a single unit with the fifth set of gear teeth and having a sixth helix angle of opposite hand relative to the fifth helix angle.

The axial force component or thrust forces developed at each mesh on the planet pinions have equal magnitude and opposite direction. The thrust force component developed at a mesh on each planet pinion is cancelled within the respective planet pinion by the thrust force component developed at the other mesh on the respective planet pinion. Therefore, there is substantially no unbalanced net thrust force component on any planet pinion that requires a reaction force to place the pinion in structural equilibrium, and no provision for a reaction force need be provided at the pinions.

Similarly, the overturning moment that is induced by the axial force component developed at each mesh is cancelled within the respective pinion by the overturning moment developed at the other mesh on the respective planet pinion. Therefore, there is substantially no unbalanced net overturning moment on any planet pinion that would requires a reaction moment/load to place the pinion in structural equilibrium. Consequently, the bearing that supports a respective pinion on the pinion shaft has reduced loading due to the elimination of the overturning moment caused by the axial load component of the mesh helix angle and reducing the risk of end loading as well.

The size of the gear set is smaller and its weight is less compared to those of a conventional planetary gear set having the same torque capacity, yet it compares favorably with respect to noise, vibration and harshness. The costs to manufacture and assemble the gear set are lower than those costs of a conventional planetary gear set.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art, such as both simple and compound Ravigneaux carriers.

### DESCRIPTION OF THE DRAWINGS

These and other advantages will become readily apparent to those skilled in the art from the following detailed description of a preferred embodiment when considered in the light of the accompanying drawings in which:

FIG. 1 is a partial sectional view of a planetary transmission gear set;

FIG. 2 is side view of a sun gear having two helical gear teeth sets;

FIG. 3 is side view of the sun gear of FIG. 2 showing the sets of gear teeth offset mutually about the axis of the sun gear;

FIG. 4 is a side view of the planet pinion and pinion shaft of FIG. 2 showing the sets of pinion teeth offset mutually about the axis of the pinion;

FIG. 5 is a perspective view showing pinion teeth engaged with the teeth of the sun gear and ring gear;

FIG. 6 is a perspective side view of a first portion of the ring gear;

FIG. 7 is a perspective side view of a second portion of a ring gear; and

FIG. 8 is a perspective side view of the first and second ring gear portions assembled as shown in the transmission of FIG. 1.

### DESCRIPTION OF THE PREFERRED EMBODIMENT

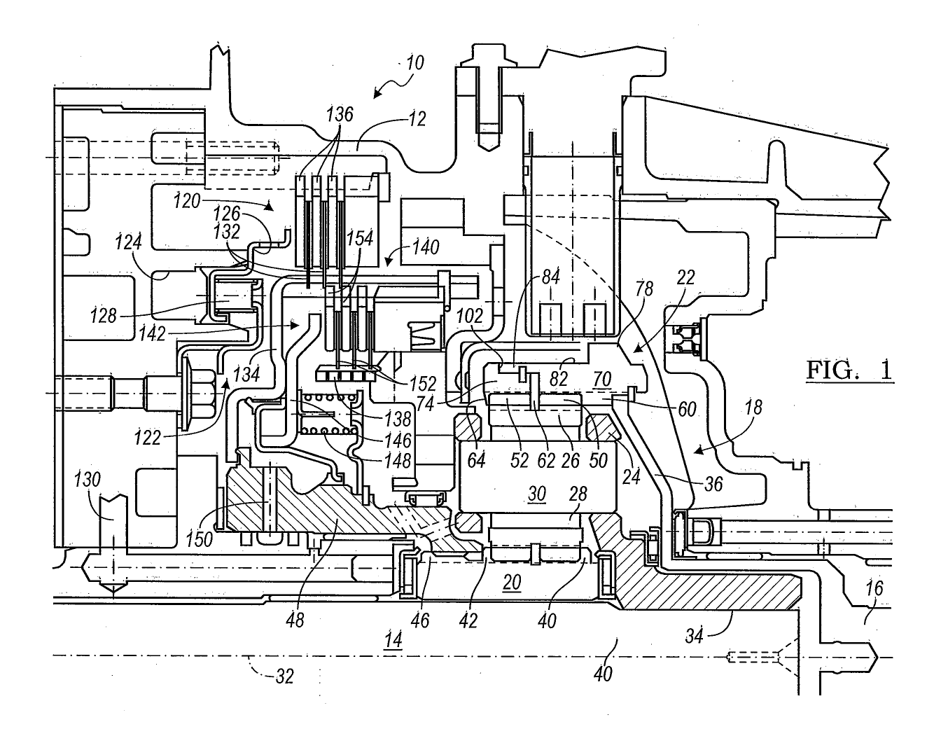

Referring now to FIG. 1, a planetary transmission 10 includes a housing 12 containing an input shaft 14 and output shaft 16 and a planetary gear assembly 18. The gear assembly 18 includes a sun gear 20, a ring gear 22, a carrier 24, and a set of planet pinions 26, supported on the carrier and meshing with the sun gear and ring gear. Each planet pinion 22 is supported by a bearing 28 for rotation on a pinion shaft 30, which is secured to the carrier 24. Each pinion shaft 30 is spaced angularly about a central axis 32 from other pinion shafts on the carrier 24, but that spacing need not be uniform about axis 32. Carrier 24 is driveably connected by a spline 34 to input shaft 14. Ring gear 22 is driveably connected by a disc 36 to output shaft 16.

A helix is a curve wound around the outer surface of a cylinder or cone that advances uniformly along the axis of the cylinder or cone as it winds around. A helix angle is the angle that a straight tangent to the helix at any point makes with an element of the cylinder or cone, such as a diametric plane perpendicular to the axis or a diametric plane parallel to the axis.

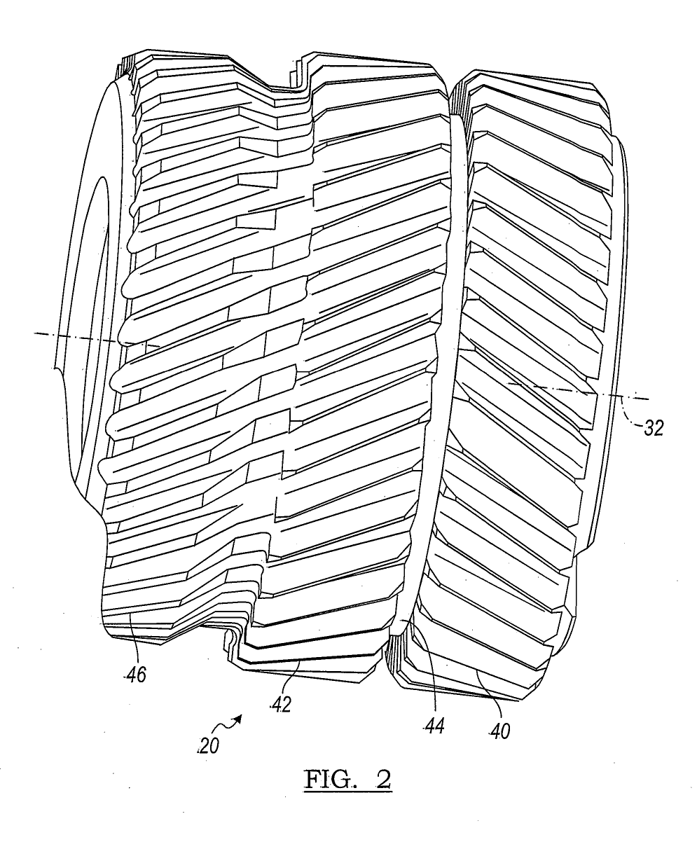

FIG. 2 shows that sun gear 20 includes two sets of gear teeth formed with mutually oppositely directed helices, a first set of teeth 40 having a right-hand helix and a face width located at the right-hand side of an annular groove 44, a second set of teeth 42 having a left-hand helix located at the left side of groove 44, and spline teeth 46, which connects sun gear 20 to a structural member 48. The annular groove 44 allows the shaper/cutters that form the gear teeth 40, 42 to travel through one set of helical teeth and to stop before reaching the other set of helical teeth. The width of groove 44 is adjustable, and in some cases may not be required depending on the manufacturing method.

Sun gear 20 is an integral unit, i.e., a unitary component formed in one piece without any connections, such as mechanical attachments, frictional engagements, interference fits or chemical bonds among constituent parts. Preferably sun gear 20 is formed as an integral unit of sintered powdered metal.

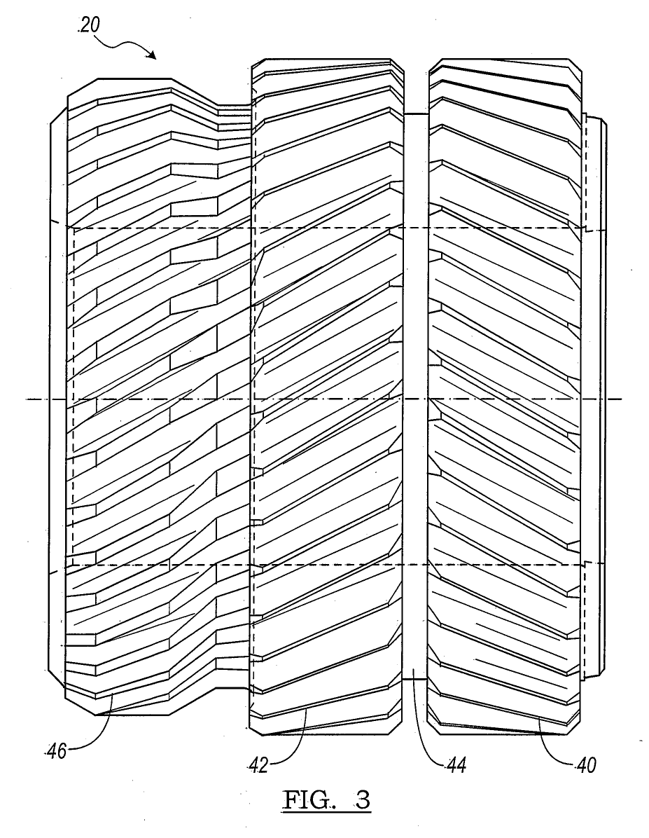

FIG. 3 shows that teeth 40 are preferably indexed or offset one-half tooth pitch with respect to teeth 42 uniformly about the axis 32 of sun gear 20. The pitch offset between the sets of teeth 40, 42 may be uniform about axis 32, but different than one-half tooth pitch, or the teeth of gear sets 40, 42 may be aligned mutually with no pitch offset.

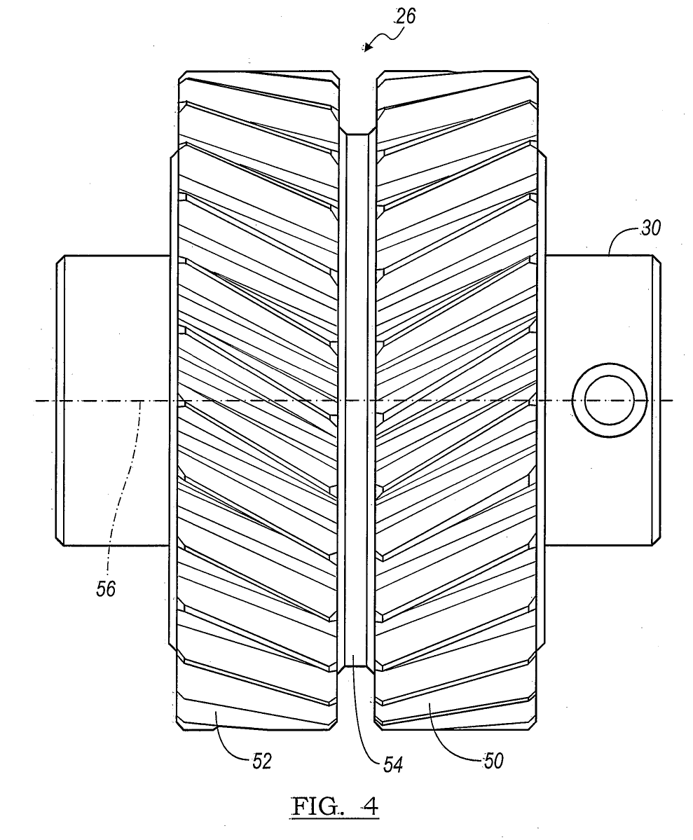

FIG. 4 shows that each planet pinion 26 is also an integral gear, which includes two sets of gear teeth formed with mutually oppositely directed helices, a first set of teeth 50 having a left-hand helix, and a second set of teeth 52 having a right-hand helix. A short annular groove 54 is located between gear teeth 50 and 52. The teeth of gear set 50 mesh with and engage the teeth of set 40 on sun gear 20, and the teeth of gear set 52 mesh with and engage the teeth of gear set 42 on the sun gear.

Each planet pinion 26 is an integral unit, i.e., a unitary component formed in one piece without any connections, such as mechanical attachments, frictional engagements, interference fits or chemical bonds among constituent parts. Preferably each planet pinion 26 is formed as an integral unit of sintered powdered metal.

FIG. 4 shows that teeth 50 are preferably indexed or offset one-half tooth pitch with respect to teeth 52 uniformly about the axis 56 of pinion 26. The pitch offset between the sets of teeth 50, 52 may be uniform about axis 56, but different than one-half tooth pitch, or the teeth of gear sets 50, 52 may be aligned mutually with no pitch offset.

Similarly, FIG. 1 shows that ring gear 22 includes two sets of gear teeth formed with mutually oppositely directed helices, a first set of teeth 60 having a left-hand helix and a face width located at the right-hand side of an annular groove 62, a second set of teeth 64 having a right-hand helix located at the left-hand side of groove 64. Preferably ring gear 22 is formed of sintered powdered metal.

The first set of gear teeth 60 of ring gear 22 are preferably indexed or offset one-half tooth pitch with respect to the teeth of the second set 64 uniformly about the axis 32 of ring gear 22. The pitch offset between the sets of teeth 60, 64 may be uniform about axis 32, but different than one-half tooth pitch, or the teeth of gear sets 60, 64 may be aligned mutually with no pitch offset. The teeth of gear set 50 mesh with and engage the teeth of gear set 60 on ring gear 22, and the teeth of gear set 52 mesh with and engage the teeth of gear set 62 on the sun gear.

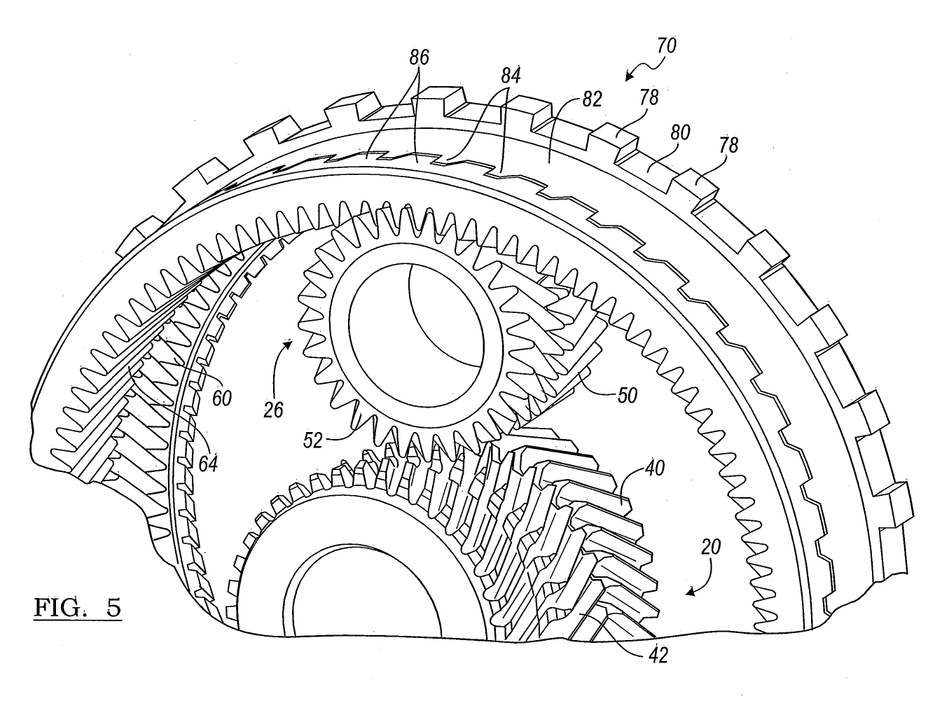

FIG. 5 shows a planet pinion 26 meshing with sun gear 20 and ring gear 22. The set of pinion teeth 50 mesh with gear teeth 60 of sun gear 20 and with gear teeth 60 of ring gear 22. The set of gear teeth 52 mesh with gear teeth 62 of sun gear 20 and with gear teeth 64 of ring gear 22.

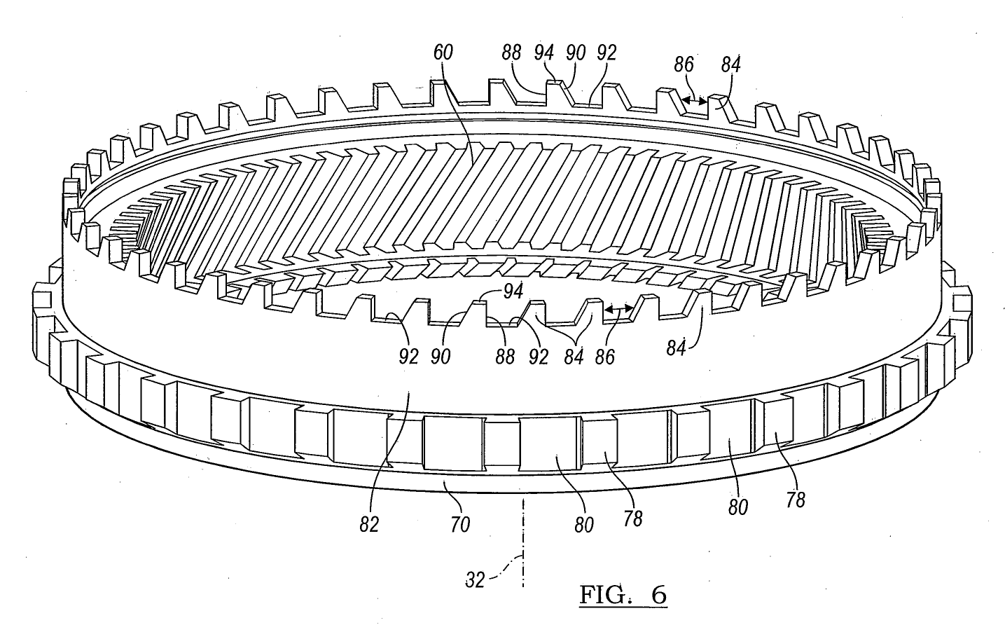

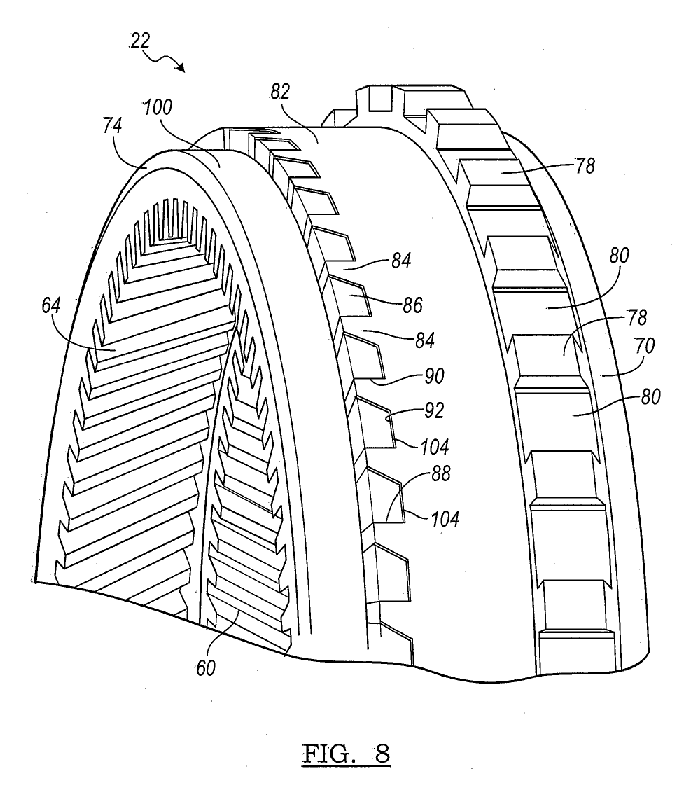

As FIGS. 6-8 illustrate, ring gear 22 is formed in two parts: a first annular portion 70 formed with the internal gear set of helical teeth 60, and a second annular portion 74 formed with the second internal gear set of helical teeth 64.

The outer surface of a circular cylinder 82 of the first ring gear portion 70 is formed with a series of angularly-spaced, radial teeth 78 and radial slots 80 angularly spaced about axis 32, each slot being located between adjacent teeth 78.

Cylinder 82 extends along axis 32 from the radial slots 80 and radial teeth 78 to a series of axial teeth 84 and spaces 86, each space being located between adjacent teeth 84 and having on open axial end. The profile of each tooth 84 is that of a trapezoid having an axial surface 88 directed along axis 32, a surface 90 extending from an axial edge 92 of surface 82 and inclined axially and circumferentially, and a circumferential surface 92 connecting surfaces 88 and 90 at the base of each tooth 84.

The outer surface of a circular cylinder 100 of the second ring gear portion 74 is formed with a series of axial teeth 102 and axial recesses 104, angularly-spaced about axis 32. The profile of each recess 104 is complementary to the profile of each tooth 84 on the first ring gear portion 70 and has an open end 106 for accepting a tooth 84 when it is inserted axially into a recess 104. Similarly, the profile of each axial tooth 102 is complementary to the profile of each axial space 86 on the first ring gear portion 70. Preferably, the number of recesses 104 is equal to the number of teeth 84, the number of spaces 86 is equal to the number of teeth 102, each axial recesses 104 is aligned with a corresponding axial tooth 84, and each axial space 86 is aligned with a corresponding axial tooth 102. When the recesses 104, spaces 86 and teeth 84, 102 engage mutually they form a drive connection between the portions 70 and 74 of ring gear 22. That connection provides torsion continuity between portions 70, 74, permits their mutual disengagement, and is indexed such that the gear teeth sets 50-60 and 52-66 are engaged with the proper pitch offset, if a pitch offset is employed.

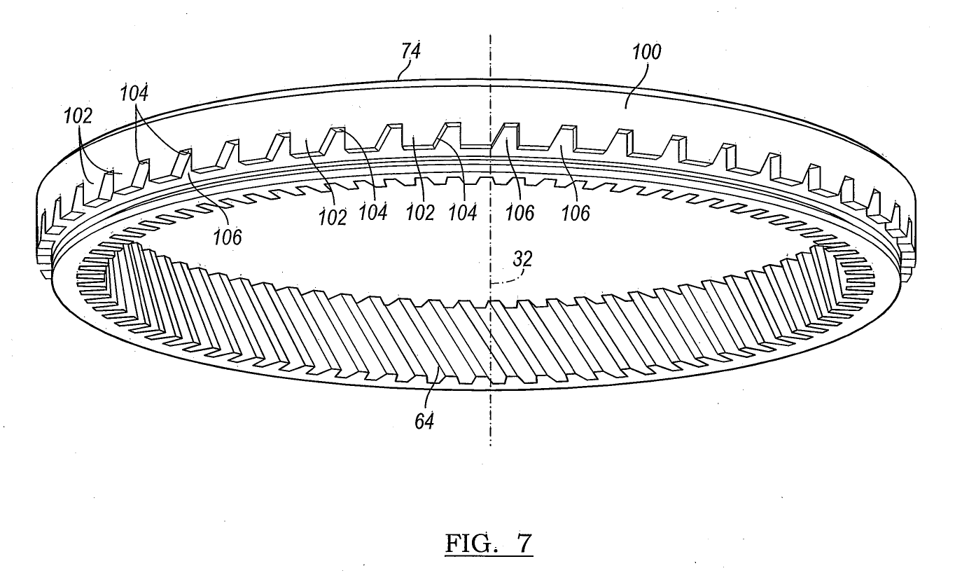

FIG. 7 shows the teeth 102 on ring gear portion 74 located in and engaged with the spaces 86 of ring gear portion 74, and the teeth 84 on ring gear portion 70 located in and engaged with the recesses 104 on ring gear portion 74.

The left-hand or right-hand helix angle of the helical gear sets 40, 50, 60 are reversed with respect to that of the corresponding helical gear sets 42, 52, 64, and they are phased or indexed, i.e., circumferentially offset mutually. For example, if the helix angle is right-handed for gear teeth 40, then the helix orientation is left-handed for gear set 42. The helical gear teeth 50 of pinions 26 are circumferentially indexed by one-half tooth pitch relative to the helical gear teeth 52 of pinions 26, and the helical gear teeth 40 of sun gear 20 are circumferentially indexed by one-half tooth pitch relative to the helical gear teeth 42 of sun gear 20. Similarly, helical gear teeth 60 of ring gear 22 are circumferentially indexed by one-half tooth pitch relative to the helical gear teeth 64 of the ring gear 22.

The axial force or thrust force component transmitted to the gear sets 50 52 of the planet pinions 26 due to their engagement with the ring gear 22 and sun gear 20 are of equal magnitude and opposite direction. For example, the thrust force component on each gear set 50, 52 of planet pinion 26 is cancelled within the respective planet pinion by the thrust force component developed at the other gear set on the respective planet pinion. Therefore, substantially no unbalanced net thrust force component is present on any planet pinion that requires a reaction force to place the pinion in structural equilibrium, and no provision for a reaction force is provided at the pinions 26.

Similarly, any overturning moment that is induced by the thrust force component transmitted to each gear set 50, 52 of pinions 26 is cancelled within the respective pinion by the overturning moment transmitted to other gear set on the respective planet pinion. Therefore, substantially no unbalanced net overturning moment is applied to any planet pinion 26 that would require a reaction moment to place the pinion in structural equilibrium. Consequently, the bearing that supports a pinion 26 on the pinion shaft 30 has virtually no end loading due to an unbalanced overturning moment on the pinion.

Sun gear 20 and ring 48 are alternately held on case 12 against rotation and released by a hydraulically-actuated brake 120, which is actuated by a servo 122 that includes a cylinder 124, a piston 124 located in the cylinder, return spring 128 for restoring the piston to the disengaged position of FIG. 1, and a hydraulic line 130, which alternately pressurizes and vents cylinder. The piston forces friction discs 132, secured to a cylinder 134, ring 48 and sun gear 20, and pressure plates 136, secured to case 12, into mutual frictional contact when the brake 120 is engaged by hydraulic pressure in cylinder 124. When the brake 120 is disengaged, spring 128 forces piston 126 leftward permitting discs 132 and pressure plates 136 to disengage mutually.

Similarly a drive connection of sun gear 20 and ring 48 to another component 138 of transmission 10 can be opened and closed alternately by a hydraulically-actuated clutch 140, which is actuated by a servo 142 that includes the cylinder 134, a piston 146 located in the cylinder, return spring 148 for restoring the piston to the disengaged position of FIG. 1, and a hydraulic line 150, which alternately pressurizes and vents cylinder 144. The piston forces friction discs 152, secured to component 138, and pressure plates 154, secured to ring 48 and sun gear 20, into mutual frictional contact when the clutch 142 is engaged by hydraulic pressure in cylinder 134. When clutch 142 is disengaged, spring 148 forces piston 146 leftward, permitting discs 152 and pressure plates 154 to disengage mutually.

In accordance with the provisions of the patent statutes, the preferred embodiment has been described. However, it should be noted that the alternate embodiments can be practiced otherwise than as specifically illustrated and described.

What is claimed is:

1. A planetary gear set comprising:
a sun gear including a first set of teeth having a first helix angle and a hand, and a second set of teeth formed as a single unit with the first set of teeth and having a second helix angle and a hand opposite to the hand of first helix angle;
a ring gear including a third set of teeth having a third helix angle and a hand, and fourth set of teeth and having a fourth helix angle and a hand opposite to the hand of the third helix angle;
a carrier; and
planet pinions supported for rotation on the carrier and engaged with the sun gear and the ring gear, each pinion including a fifth set of teeth having a fifth helix angle and a hand, and sixth set of gear teeth formed as a single unit with the fifth set of teeth and having a sixth helix angle and a hand opposite to the hand of the fifth helix angle.

2. The gear set of claim 1, wherein the teeth of the first set are circumferentially indexed by one-half tooth pitch relative to the teeth of the second set.

3. The gear set of claim 1, wherein the teeth of the third set are circumferentially indexed by one-half tooth pitch relative to the teeth of the fourth set.

4. The gear set of claim 1, wherein the teeth of the fifth set of each planet pinion are circumferentially indexed by one-half tooth pitch relative to the teeth of the sixth set.

5. The gear set of claim 1, wherein the teeth of the first set and the teeth of the second set are formed from powdered metal and as a single unit without mechanical or bonded connections.

6. The gear set of claim 1, wherein the teeth of the third set and the teeth of the fourth set of each planet pinion are formed from powdered metal and as a single unit without mechanical or bonded connections.

7. The gear set of claim 1, wherein the ring gear is formed from powdered metal.

8. A planetary gear set comprising:
a sun gear mounted for rotation about an axis, including a first set of gear teeth having a first helix angle and second set of gear teeth formed as a single unit with the first set of gear teeth and having a second helix angle of opposite hand relative to the first helix angle;
a ring gear including:
a first portion including a third set of internal gear teeth having a third helix angle, and first clutch teeth, each clutch tooth being spaced about the axis and extending along the axis, and
a second portion including a fourth set of internal gear teeth having a fourth helix angle being of opposite hand relative to the third helix angle, and second clutch teeth spaced about the axis and engagable by the first clutch teeth;
a carrier; and
planet pinions supported for rotation on the carrier and engaged with the sun gear and the ring gear, each pinion including a fifth set of teeth having a fifth helix angle, and sixth set of gear teeth formed as a single unit with the fifth set of gear teeth and having a sixth helix angle of opposite hand relative to the fifth helix angle.

9. The gear set of claim 8, wherein the teeth of the first set are circumferentially indexed by one-half tooth pitch relative to the teeth of the second set.

10. The gear set of claim 8, wherein the teeth of the third set are circumferentially indexed by one-half tooth pitch relative to the teeth of the fourth set.

11. The gear set of claim 8, wherein the teeth of the fifth set of each planet pinion are circumferentially indexed by one-half tooth pitch relative to the teeth of the sixth set.

12. The gear set of claim 8, wherein the teeth of the first set and the teeth of the second set are formed from powdered metal and as a single unit without mechanical or bonded connections.

13. The gear set of claim 8, wherein the teeth of the third set and the teeth of the fourth set of each planet pinion are formed from powdered metal and as a single unit without mechanical or bonded connections.

14. The gear set of claim 8, wherein the ring gear is formed from powdered metal.
